(19) United States
(12) Patent Application Publication
(10) Pub. No.: US 2014/0006127 A1
(43) Pub. Date: Jan. 2, 2014

(54) Systems and Methods for Earning Virtual Value Associated with Transaction Account Activities

(71) Applicant: Serve Virtual Enterprises, Inc., St. Petersburg, FL (US)

(72) Inventors: Brian DeCook, Tampa, FL (US); Matthew Gray, St. Petersburg, FL (US); David Lieberman, St. Petersburg, FL (US); Cory Moreira, St. Petersburg, FL (US); Melissa Nolen, New York, NY (US); Ann Sattin, New York, NY (US); Tahnee Singh, New York, NY (US); Ian Swanson, St. Petersburg, FL (US)

(21) Appl. No.: 13/899,221

(22) Filed: May 21, 2013

Related U.S. Application Data
(63) Continuation-in-part of application No. 13/540,216, filed on Jul. 2, 2012.

(51) Int. Cl. G06Q 30/02

(52) U.S. Cl. CPC G06Q 30/0226; G06Q 30/0208; G06Q 30/0215
USPC 705/14.17

(57) ABSTRACT

The disclosure includes comprehensive system and methods for enabling a user of a social gaming service to receive additional virtual value based on transaction account activities in the physical world. A participant that is registered with the system and that is issued a participating transaction account may receive loyalty points in the form of at least one of virtual currency and/or virtual goods in response to activities associated with a participating/linked transaction account, such as an open loop pre-paid transaction account.

### CROSS-REFERENCE TO RELATED APPLICATIONS

This application is a Continuation-In-Part of, claims priority to and the benefit of, U.S. patent application Ser. No. 13/540,216, entitled “Systems and Methods for Transferring Value via a Social Network’ and filed on Jul. 2, 2012. The aforementioned application is incorporated by reference in its entirety for all purposes.

### FIELD

The present disclosure generally relates to loyalty programs associated with transaction accounts.

### BACKGROUND

Social gaming services are greatly increasing in number and popularity with the most popular services boasting a large amount of registered users. Users of social gaming services often associate with other members of the service and develop strong levels of loyalty to these social games. However, a long felt need exists for an integrated, end-to-end, automated system that enables a social gaining user to earn additional value, within their respective gaming platforms.

### SUMMARY

Methods and systems described herein enable a user of a social gaming service to receive additional virtual value based on spend in the physical world. In various embodiments, a participant registered with the system and issued a participating transaction account may receive loyalty points in the form of at least one of virtual currency and/or virtual goods, in response to activities associated with a participating/linked transaction account (e.g., an open loop pre-paid transaction account).

In various embodiments, a computer-based method is disclosed herein. This computer-based method may comprise receiving a notification associated with an open loop pre-paid transaction account and/or an activity related to an open loop pre-paid transaction account. The system may include retrieving information from a loyalty program database associated with the open loop pre-paid transaction account, including information regarding a first virtual purse selected by a participant to deposit reward value. The system may include assessing an amount of value to be deposited in the selected first virtual purse based on the activity and an eligibility look-up table using a computerized conversion processor specific to the selected first virtual purse. The system may include transmitting the assessed amount of value to be deposited in the selected first virtual purse.

According to various embodiments, the request to deposit value may comprise an open loop prepaid transaction account identifier. This may be a proxy transaction account identifier. The value to be deposited may be an amount of virtual currency and/or an amount of virtual goods. The amount of virtual currency and/or an amount of virtual goods deposited may be determined based on a table of conversion rates for each virtual purse. This table of conversion rates, specifically the conversion rates for each game (and each virtual purse) may be updated at any time (e.g., on certain dates, periodically, etc).

According to various embodiments, the system may further include receiving the value deposit request based on at least one of an activation of the open loop pre-paid transaction account, spend via the open loop pre-paid transaction account, engagement triggers, depositing money on the open loop pre-paid transaction account, velocity of spend, amount of spend (e.g., exceeding a preselected threshold), periodic spend (e.g., over a period of days) and/or the like. According to various embodiments, the spend via the open loop pre-paid transaction account is associated with products that are not associated with the host of the virtual purse. Thus, the spend is not related to the gaming system or its operations.

According to various embodiments, the system may include proportioning, by the computer-based system, an amount of value to be deposited between the selected first virtual purse and a second selected virtual purse. The value deposit request may be transmitted at any time, such as in concert with a transaction authorization request associated with the open loop prepaid transaction account. The first virtual purse comprises a social gaming virtual purse.

According to various embodiments, the system may be configured to award loyalty points to the open loop prepaid transaction account, in addition to the deposit value in the selected first virtual purse. The designated first virtual purse selected by a participant may be de-selected, changed and/or adjusted to a second virtual purse. The participant may be the holder of the open loop pre-paid transaction account.

According to various embodiments, a physical open loop pre-paid transaction instrument associated with the open loop pre-paid transaction account may be branded and/or co-branded with a designator of the holder of the first virtual purse. A notification may be transmitted to the participant that the assessed amount of value has been delivered to the selected first virtual purse.

### BRIEF DESCRIPTION OF THE DRAWINGS

A more complete understanding of the present disclosure may be derived by referring to the detailed description and claims when considered in connection with the Figures, wherein like reference numbers refer to similar elements throughout the Figures, and:

FIG. 1 is a block diagram illustrating major system components of a value transfer system, in accordance with various embodiments; and

FIG. 2 is a flow chart illustrating an exemplary process for earning virtual currency in response to transaction account activity, in accordance with various embodiments.

### DETAILED DESCRIPTION

The systems and methods provide an improved, automated, integrated, online system for accruing reward value (e.g., a virtual value) to a participant of a third party service (e.g., a social gaming user). This reward value may be accrued in response to activities associated with a transaction account. The transaction account may be any type of transaction account, such as an open loop prepaid transaction account.

Open system prepaid card/accounts are generally not credit cards, although they are sometimes marketed as “prepaid credit cards.” Credit is not offered by the open system prepaid account issuer and the cardholder spends money which has been prepaid to an account. Therefore, these cards are also generally marketed as “prepaid debit cards,” The value, which has been prepaid to the account, is not physically stored on the card. Rather, the card number uniquely identifies a record in a database, where a balance specific to the open system prepaid card/accounts is recorded. These accounts are similar to closed system prepaid cards, but are endorsed by a retail electronic payments network and can generally (unlike gift cards) be used anywhere debit cards with the same logo may be used. They are very similar to a debit card, except that a checking account is generally not associated with these accounts. These accounts are also sometimes referred to as “open loop” cards.

Open loop cards/accounts that do not include or require brick and mortar linked checking accounts may be particularly appealing to those that participate in social gaming. A broad percentage of the population includes social gaming users, which are typically early adopters of new technology. Also, young people with short credit histories are included in the social gaming population and they are particularly well-suited for an open system prepaid card/account.

Another example of an open system prepaid account is a payroll card. In general, payroll cards are used by employers to pay employees. These accounts may take the place of issuing cheeks or direct depositing to a checking account.

While the embodiments described herein are described in sufficient detail to enable those skilled in the art to practice the disclosure, it should be understood that other embodiments may be realized and that logical and mechanical changes may be made without departing from the spirit and scope of the invention. Thus, the detailed description herein is presented for purposes of illustration only and not of limitation.

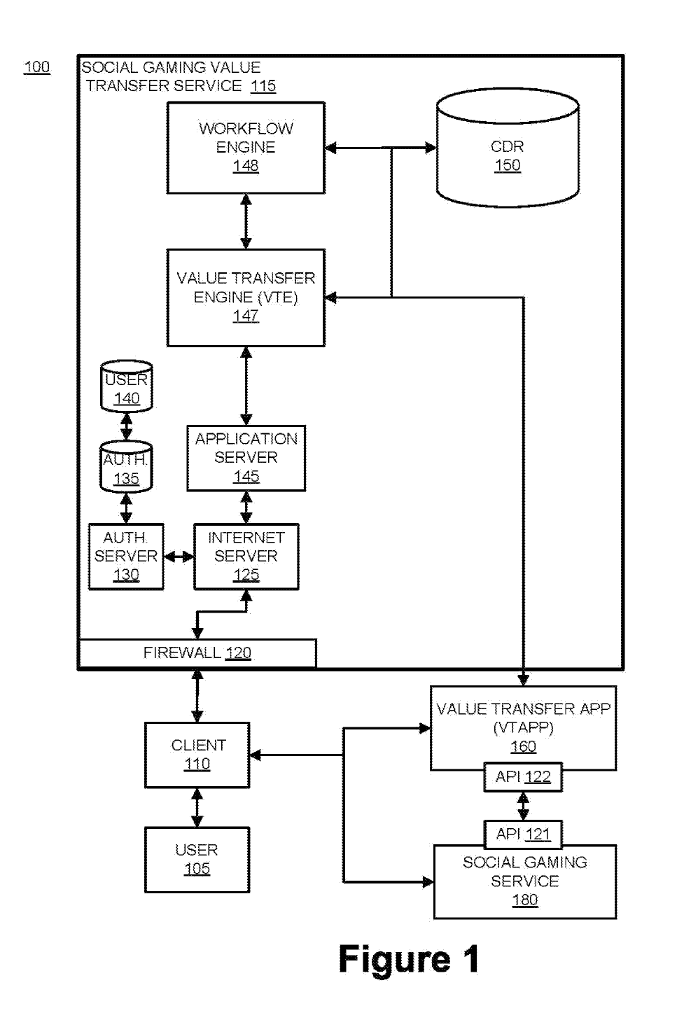

FIG. 1 shows an exemplary block diagram illustrating major system components for enabling system 100. In various embodiments, elements of the social gaming value transfer service 115 may, at times, couple a participant 105 via a client 110 with a network connection to an Internet server 125 by way of the Internet. In various embodiments, Internet server 125 employs authentication server 130 to validate credentials, assign proper permissions, and retrieve preferences information for authorized user's 105 of transfer service 115. For various processes, such as settlement, notification, election of preferences, and value transfer requests, transfer service 115 may communicate through one or more application program interface 122, 121, with a social gaming service 180, such as a back-end system of a third party social gaming service. These elements and their operation are further described below.

According to various embodiments, a participant 105 may be a user of an online social network and/or gaming platform/system 180. The participant 105 may be offered a transaction account which provides a value add to the participant 105 in the social gaming platform. This offer may include terms and conditions. This offer may be communicated via the online social network and/or gaming platform/system 180. This offer may occur at any time, but is preferably after a user is associated with the online social network and/or gaming platform/system 180, such as with an established user gaming account. This value add, may be in form of virtual dollars and/or virtual goods in the participant's 105 online social network and/or gaming platform/system 180. These virtual dollars and/or virtual goods may be earned in a virtual purse distinct to each virtual game of the user's account.

According to various embodiments, virtual dollars and/or virtual goods may be earned automatically and directly in the online social network and/or gaming platform/system 180 for activities related to a transaction account. Stated another way, in the present system a participant 105 does not earn points in a loyalty account held by a transaction issuer and then actively convert those loyalty account points into virtual dollars and/or virtual goods in the online social network and/or gaming platform/system 180.

A participant 105 may accept the offer of the transaction account. This acceptance, may include the participant 105 applying via an application for the transaction account. Details concerning this communication between the participant 105 and the various other entities are described in greater detail below. This application information may be communicated to a transaction account issuer by the online social network and/or gaming platform/system 180 host or the participant may communicate directly, such as via a hyperlink from the online social network and/or gaming platform/system 180 with the transaction account issuer. As previously stated, the transaction account may be any transaction account, such as an open loop pre-paid transaction account. This transaction account may be issued to the participant 105 for use in the “real” world for the purchase/spend on goods and services (e.g. products). This transaction account may be issued as a transaction instrument. According to various embodiments, the transaction instrument is branded with the information associated with the online social network and/or gaming platform/system 180 and/or co-branded with information associated with the online social network and/or gaming platform/system 180 and information associated with the transaction account issuer. This brand and/or co-brand may be a trademark, logo, graphic, symbol, phrase and/or the like.

The transaction account may be linked to the one or more user accounts in the online social gaming platform/system 180. According to various embodiments, the transaction account code may not be communicated with the online social gaming platform/system 180. The social gaming platform/system 180 may be given a code, such as a proxy code to identify the transaction account and/or its holder. Stated another way, a proxy identifier may be used between the transaction account issuer and the online social gaming platform/system 180 host to identify a participant.

Activities associated with the transaction account may earn the participant 105 virtual currency or virtual goods in a designated gaming platform. This designation may be elected by the user. This designation may be changed and/or modified at any suitable time. For instance, a participant 105 may initially designate a first gaming system associated with a first user account in the gaming platform/system to receive value associated with activates related to the transaction account. A participant 105 may later designate a first gaming system associated with a second user account in the first gaming system/gaming platform to receive value associated with activates related to the transaction account.

In various embodiments, a participant 105 may initially designate a first gaming system associated with a first user account in the gaming platform/system to receive value associated with activates related to the transaction account. A participant 105 may later designate a second gaming system associated with a second user account in the second gaming system/gaming platform to receive value. In various embodiments, a participant 105 may designate, according to proportions a first gaming system associated with a first user account in the gaming platform/system to receive value associated with activates related to the transaction account and a second gaming system associated with a second user account in the gaming platform/system to receive value associated with activates related to the transaction account. These proportions may be selected by the user. Alternatively, these proportions may be triggered in response to reaching thresholds within the virtual gaming platform. For instance, once a certain amount of total virtual currency is achieved in a first user account, the reward value funding of that account via system 100 may be reduced or eliminated in favor of increasing a second user account in the same or different gaming platform, automatically according to a hierarchy established by the user. The first gaming system and the second gaming system/platform may be hosted by the same entity.

Each gaming platform may have a unique exchange rate associated with the value that is earned associated with activates related to the transaction account. For instance, a reward value for an amount of spend in dollars may be converted, such as by a value transfer engine 147, into an amount of online social network and/or gaming platform/system 180 virtual currency or virtual goods. This may be at the gaming host level and/or this may be game specific. For instance, each game of a plurality of games hosted by the online social network and/or gaming platform/system 180 may comprise an individual exchange rate and individual purse to accrue reward value. For instance, to spur activity the online social network and/or gaming platform/system 180, a favorable exchange rate may be offered for a first game and a different exchange rate for a second game. Alternatively, various games often have different currency models of vastly different scales, thus each game may have an associated exchange rate of reward value for an amount dollars spent to points, reward value for an amount dollars to virtual dollars, or reward value for an amount dollars to virtual goods. These exchange rates may be communicated from the online social network and/or gaming platform/system 180 to the transaction account issuer, such as for storage in the value transfer engine 147 and/or conversion processor. These exchange rates may be communicated at any suitable time, such as periodically, seasonally, according to holidays, promotions, weather conditions, and/or the like. According to various embodiments, as the value of the currency in the gaming platform goes up or down the transaction account issuer may adjust its exchange rate settings accordingly.

Value may be accrued based on various activities associated with the transaction account. According to various embodiments, the system 100 may receive/transmit a value deposit/request of value deposit based on at least one of an activation of the transaction account, spend via the transaction account, enrollment of an existing account with the system, fulfilling engagement triggers, depositing money on a pre-paid transaction account, linking a funding source, maintaining a balance of available funds over a preselected threshold, velocity of spend over a preselected period, amount of spend, such as exceeding a preselected threshold of dollars spent, periodic spend, such as over a period of days and/or the like. Engagement triggers may used to stimulate additional spend, and/or additional social gaming play. These may include notifications of activities whose fulfillment may result in reward of additional value deposit.

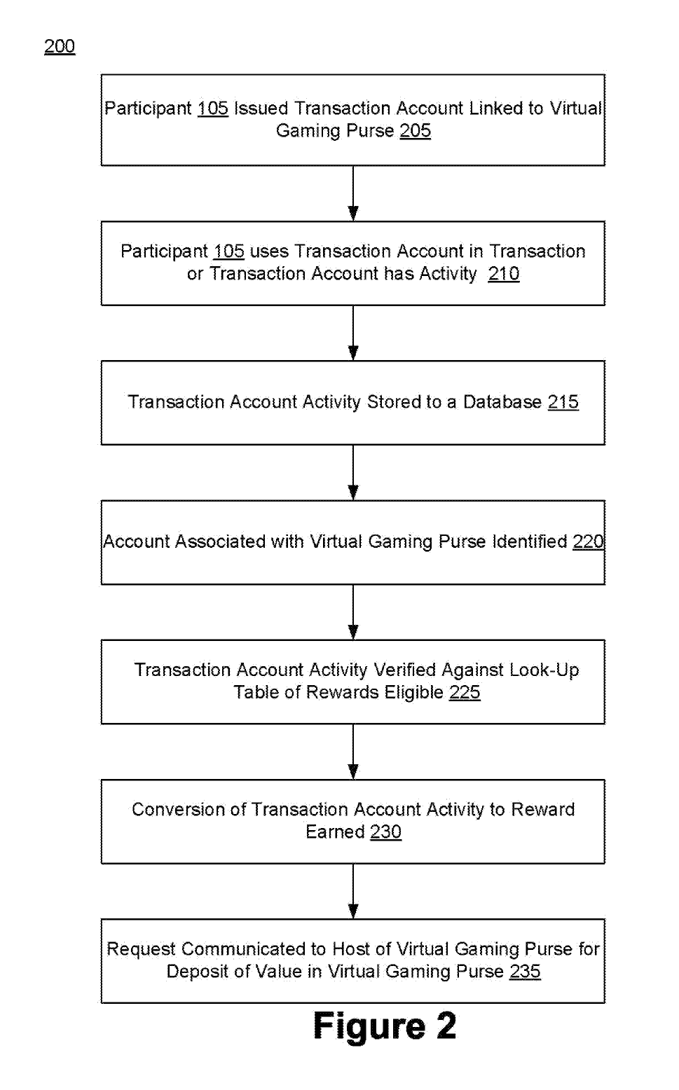

In operation, according to various embodiments and with reference to FIG. 2, a participant 105 who has been issued a transaction account (step 205), by a transaction account issuer may use the transaction account in a transaction, such as to purchase groceries (step 210). This transaction account activity may be stored to a database (step 215). The transaction account activity stored to the database may be compared against a look-up table of eligible awards, (step 225). The reward eligibly may be specific to the social gaming platform and/or social gaming site selected by the participant 105 to be linked to the transaction account. (220). This comparison may be performed at any time, such as substantially simultaneously with the transaction activity, in a batch process, on a period basis and/or the like.

According to various embodiments, a conversion (e.g., via a value transfer engine 147) may be made according to an exchange rate associated with the specific user account in a specific gaming arena/platform (step 230). This conversion may relate the activity associated with the transaction account to an amount of virtual currency earned, points earned, or virtual goods earned. For instance, the amount of money spent on groceries may accrue an amount of virtual currency based on the amount of dollars spent. According to various embodiments, the class/type of product purchased in the real world may affect the conversion rate. For instance, dollars spent on groceries may achieve a higher exchange rate than dollars spent on airline travel.

According to various embodiments, in response to the class/type of product purchased being associated with the type of game, such as via a merchant designation by Merchant Category Code (MCC), may earn a higher exchange rate (bonus) than dollars spent on a different class/type of product purchased. For example dollars spent on groceries may achieve a higher exchange rate than dollars spent on airline travel in an online social farming game based on the association between the game and the real world products. The merchant, gaming account host and/or transaction account issuer may set exchange rate bonuses for any reason.

With continued reference to FIG. 2, a message containing various information, such as an identifier of the transaction account, such as a proxy code which has previously been converted from the identifier of the transaction account, a designation of which incentive is desired to be communicated, and/or a request for an amount of value to be added to a virtual purse associated with a online social network and/or gaming platform/system 180 may be communicated from an account issuer to an online social network and/or gaming platform system 180 (step 235). According to various embodiments, the dollar value associated with the amount of value to be added to a virtual purse and/or the date an associated transaction may be communicated. This request/message may be verified for accuracy, such as the form and/or structure of the request may be verified. An error message may be communicated to the sender in response to detection of an error the form and/or structure of the request message. The details of the request may be verified by the social network and/or gaming platform system 180. This response message may be substantially synchronous with the request message.

These communications may be through an interface, such as a computerized network configured for exchanging information. If the protocols of the account issuer and the online social network and/or gaming platform/system 180 conform this communication may be direct through a network. At times, this communication may be through an Application Program Interface (API). The API may be hosted by the online social network and/or gaming platform/system 180 and/or the transaction account issuer. In response to the transaction and an election/designation by the participant 105 of which user account within the gaming system the participant 105 desires to earn value, a message requesting value, such as virtual value, to be deposited in the user account is sent. A message may be sent from the social network and/or gaming platform/system 180 to the transaction account issuer that a deposit was made into the account. An in-game activity may be associated with the deposit of value in the purse, such as a graphic and/or animation being displayed and or notification posted to the gaming user account through a gaming interface. Information designating which in-game activity to display may be communicated from the transaction account issuer to the social network and/or gaming platform system 180 based on the conversion/exchange calculated. Based on the calculation and the virtual purse selected an in-game activity may be retrieved from a look-up table. This in-game activity may be different based on the virtual purse/game associated with the value transfer. This message may be substantially synchronous with the request to deposit of virtual credit into the account. A parallel process may be performed where a batch report of all deposits or a subset of all deposits by the social network and/or gaming platform/system 180 in a non-real-time environment are compared against the substantially real-time communicated and recorded deposits as a verification of deposits made. According to various embodiments, the online social network and/or gaming platform/system 180 may perform the conversion of virtual currency and/or goods earned tied to the transaction account activities. They may perform this conversion once being sent information regarding spend from the transaction account issuer.

“Participant” may include any individual, consumer, consumer, group, business, organization, government entity, transaction account issuer or processor (e.g., credit, charge, etc), merchant, consortium of merchants, consumer, account holder, charitable organization, software, hardware, and/or any other entity.

“Social gaming” and/or virtual gaming as used herein may refer to participating in, playing or being associated with electronic games as a way of social interaction. Social gaming may be a way to minimize or avoid playing games in solitude. It may refer to card games, virtual gambling, social network games (e.g. games that have social network integration or elements), virtual board games, multiplayer video games, where more than one person can play in the same game environment, such as at the same time or to affect other players, role-playing games (e.g., a game in which players assume the roles of characters in a fictional setting), simulation games, and/or alternate reality games, an interactive narrative that offers a platform to explore possible situations and social interactions while avoiding real world consequences. For intance, Zynga™ is an example of a host and/or provider of social gaming services.

An “account”, “account number,” or “account identifier” as used herein, may include any device, code (e.g., one or more of an authorization/access code, personal identification number (“PIN”), Internet code, other identification code, and/or the like), number, letter, symbol, digital certificate, smart chip, proxy code, digital signal, analog signal, biometric or other identifier/indicia suitably configured to allow the consumer to access, interact with or communicate with the system. The account number may optionally be located on or associated with a stored value account, rewards account, charge account, credit account, debit account, prepaid account, telephone card, embossed card, smart card, magnetic stripe card, bar code card, transponder, radio frequency card or an associated account. The system may include or interface with any of the foregoing accounts or devices, or a transponder and RFID reader in RF communication with the transponder (which may include a fob). Typical devices may include, for example, a key ring, tag, card, cell phone, mobile device, wristwatch or any such form capable of being presented for interrogation.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

A “transaction account” may include any account that may be used to facilitate a financial transaction. A financial institution or transaction account issuer includes any entity that offers transaction account services to consumers. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution, but these participants are not shown.

A “financial processor,” “payment network,” or “payment system” or “transaction account issuer” may include any entity which processes transactions, issues accounts, acquires financial information, settles accounts, conducts dispute resolution regarding accounts, and/or the like.

In various embodiments, Internet server 125 employs application server 145 to manage various applications and utilities that are utilized by system 100. In various embodiments, application server utilizes APL+Win, JBOSS utilizing SEAM, Richfaces JBPM, and/or other Java libraries (jQuery and Javascript), JAS-WS, Apache POI, and/or Quartz. In various embodiments, Internet server 125 interacts directly with the various systems and components disclosed herein.

Transfer service 115 may include any number of computing platforms and databases such as, for example, vale transfer engine (“VTE”) 147, workflow engine 148 and central data repository (“CDR”) 150. Other systems may include, for example, connections to social gaming systems/services 180, such as via a social gaming system API 121, value transfer API 122, accounting systems, financial transaction systems, reporting systems, new accounts systems, management information systems, business information systems, external data sources, proprietary systems and the like. Each of the systems may be interconnected within by a network in via any method and/or device described herein. A middleware server and/or application server 145 may serve as an intermediary between the various systems to ensure appropriate communications between disparate platforms. A report engine retrieves and/or is provided with data from certain of the various systems in order to generate notices, bills, messages, audit reports, settlement and the like.

System 100, transfer service 115 and/or any other components discussed herein may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

As will be appreciated by one of ordinary skill in the art, one or more of the components of system 100 may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an interact based embodiment, an entirely hardware embodiment, or an embodiment combining aspects of the internet, software and hardware. Furthermore, the system may take the form of a computer program product on a computer-readable storage medium, such as a non-transitory computer-readable storage medium having computer-readable program code means embodied in the storage medium. Any suitable computer-readable storage medium may be utilized, including hard disks, CD-ROM, optical storage devices, magnetic storage devices, and/or the like.

The system contemplates uses in association with web services, transaction processing, utility computing, pervasive and individualized computing, security and identity solutions, autonomic computing, commodity computing, mobility and wireless solutions, open source, biometrics, grid computing and/or mesh computing.

Participant 105 may be the holder of a transaction account. Participant 105 may be the holder of a social gaming and/or online gaming user account. Participant 105 may include any entity that utilizes system 100 or transfer service's 115 functionality. Participant 105 may include, for example, a user of social gaming service 180 that wishes to apply for/be issued a transaction account and/or link an existing transaction account to elements of the social gaming service 180. In various embodiments, value transfer application (VTAPP) 160 accesses social gaming service 180 via API 121 and/or API 122. In various embodiments, Participant 105 may interface with transfer service 115, social gaming service 180 and/or VTAPP 160 via any communication protocol, device or method discussed herein or known in the art. For example, Participant 105 may interact with transfer service 115 by way of an Internet browser at client 110.

Client 110 comprises any hardware and/or software suitably configured to facilitate requesting, retrieving, updating, analyzing, entering and/or modifying data. For example, in various embodiments, client 110 is configured to facilitate input, receipt, presentations, analysis and/or review of information relating social gaming services, loyalty systems, virtual currency, value transfer services, etc. For instance, Participant 105, via client 110, may elect/designate a virtual purse of a virtual gaming system for deposit of transaction account activity rewards. Client 110 includes any device (e.g., personal computer) which communicates (in any manner discussed herein) with transfer service 115, VTAPP 160 and/or social gaming service 180 via any network discussed herein. Such browser applications comprise Internet browsing software installed within a computing unit or system to conduct online transactions and/or communications. These computing units or systems may take the form of a computer or set of computers, although other types of computing units or systems may be used, including laptops, notebooks, hand held computers, set-top boxes, workstations, computer-servers, main frame computers, mini-computers, PC servers, pervasive computers, network sets of computers, and/or the like. Practitioners will appreciate that client 110 may or may not be in direct contact with transfer service 115 or VTAPP 160. For example, client 110 may access the services of transfer service 115 through another server, which may have a direct or indirect connection to Internet server 125. Client 110 may access VTAPP 160 via social gaming service 18C. Client 110 may be mobile or may be located in a home or business environment with access to a network. In an exemplary embodiment, access is through a network or the Internet through as commercially-available web-browser software package.

As those skilled in the art will appreciate, client 110 includes an operating system (e.g., Windows NT, 95/98/2000, OS2, UNIX, Linux, Solaris, MacOS, Android, iPhone OS etc.) as well as various conventional support software and drivers typically associated with computers or computing devices. Client 110 may include any suitable personal computer, mobile device, phone, network computer, workstation, minicomputer, mainframe or the like. Client 110 can be in a home or business environment with access to a network. In an exemplary embodiment, access is through a network or the Internet through a commercially available web-browser software package.

In various embodiments, various components, modules, and/or engines of system 100 may be implemented as micro-applications or micro-apps. In various embodiments, VTAPP 160 is a micro-app that runs on client 110 (e.g. a mobile device). Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the mico-app desires an input from a user, the micro-app may be configured to request a response from the operating system which monitors various hardware components and then communicates a detected input from the hardware to the micro-app.

Client 110 may be independently, separately or collectively suitably coupled to the network via data links which includes, for example, a connection to a wireless service provider or an Internet Service Provider (ISP). ISP connections over the local loop is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network.

Client 110 may include any number of applications, code modules, cookies, and the like to facilitate interaction with the various components of System 100 as shown, for example in FIG. 1. Such interaction may include for example, input data, complete templates/forms, view reports, validate data, approve data, and the like. In various embodiments, client 110 may store user 105 preferences and/or any other information disclosed herein on a hard drive or any other local memory device. Accordingly, client 110 may retrieve and store consumer information within a memory structure of client 110 in the form of a browser cookie, for example. In another embodiment, client 110 retrieves information relating to user 105 from transfer service 115 on establishing a session with Internet server 125.

Firewall 120, as used herein, may comprise any hardware and/or software suitably configured to protect transfer service 115 components from users, other networks and systems. Firewall 120 may reside in varying configurations including stateful inspection, proxy based and packet filtering among others. Firewall 120 may be integrated as software within Internet server 125, any other transfer service 115 components or may reside within another computing device or may take the form of a standalone hardware component. Although depicted as a single firewall in FIG. 1, one skilled in the art will recognize that a firewall or multiple firewalls may be implemented throughout system 100 and/or transfer service 115 to enable system and data security.

Internet server 125 may include any hardware and/or software suitably configured to facilitate communications between client 110 and one or more transfer service 115 components. Further, Internet server 125 may be configured to transmit data to client 110 within markup language documents (e.g., XML, HTML, etc.). As used herein, “data” may include encompassing information such as commands, queries, files, data for storage, and/or the like in digital or any other form. Internet server 125 may operate as a single entity in a single physical location or as separate computing components located together or in separate physical locations.

Internet server 125 may provide a suitable web site or other Internet-based graphical user interface which is accessible by consumers. In various embodiments, Internet server 125 employs RedHat Linux Enterprise 5.x Server and Apache Http server. In various embodiments, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Any of the communications, inputs, storage, databases or displays discussed herein may be facilitated through a web site having web pages. The term “web page” as it is used herein is not meant to limit the type of documents and applications that might be used to interact with the user. For example, a typical web site might include, in addition to markup language based documents (e.g., HTML), various forms, Java applets, JavaScript, active server pages (ASP), common gateway interface scripts (CGI), extensible markup language (XML), dynamic HTML, cascading style sheets (CSS), helper applications, plug-ins, and/or the like. A server may include a web service that receives a request from a web server, the request including a URL (e.g. http://yahoo.com/stockquotes/ge) and an IP address (e,g. 123.4.56.789). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

In order to control access to components of transfer service 115, Internet server 125 may invoke authentication server 130 in response to user 105 submissions of authentication credentials received at Internet server 125 from client 110. Authentication server 130 may include any hardware and/or software suitably configured to receive authentication credentials, encrypt and decrypt credentials, authenticate credentials, and grant access rights according to privileges (e.g., pre-defined privileges) attached to the credentials. Authentication server 130 may grant varying degrees of application and data level access to users based on information stored within a database and/or any other known memory structure.

VTE 147 comprises hardware and/or software modules that execute processes, access data from CDR 150 and interact with workflow engine 148 to enable the functionality of transfer service 115. For example, VTE 147 may receive a request to create a new user and assign/associate one or more virtual gaming purses to the transaction account 170 and may executed various automated processes to create the new user and to populate data on CDR 150 such that the functionality of VTAPP 160 may be tested using the new user.

Workflow engine 148 comprises hardware and/or software modules that implement process definition, tracking and execution. Workflow engine 148 may comprise one or more software applications, modules or data objects. The software may be any executable code written in any software programming language, such as, for example Java®. For example, workflow engine 148 reads data from CDR 150 and instantiates a data object (e.g. a Java Bean®) to store the data for use by software modules or other objects. In various embodiments, workflow engine 148 executes an automated or partially automated process such as a user account creation process, user creation or deletion process, data population process, etc.

CDR 150 may include any hardware and/or software suitably configured to facilitate storing data relating to, for example, user accounts, user account identifiers, association of user account identifiers, pending transactions, transaction history, account balances, registration, transactions, account settings, user settings, look-up tables, eligible rewards, reward bonus information, etc.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, the system includes special purpose computers, user interfaces (UIs), software modules, logic and/or workflow engines, numerous databases and computer networks. While the system may contemplate upgrades or reconfigurations of existing processing systems, changes to existing databases and system tools are not necessarily required by the system and method.

While the description references specific technologies, hardware, equipment, system architectures and data management techniques, practitioners will appreciate that this description discusses various embodiments and that other devices and/or methods may be implemented without departing from the scope of the disclosure. Similarly, while the description may reference a user interfacing with the system via a personal computer user interface, practitioners will appreciate that other interfaces may include mobile devices, smart phones, tablet computing devices, kiosks and handheld devices such as personal digital assistants.

One skilled in the art will appreciate that system 100 may employ any number of databases in any number of configurations. Further, any databases discussed herein may be any type of database, such as relational, hierarchical, graphical, object-oriented, and/or other database configurations.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in various embodiments, the header or trailer is not stored on the transaction device along with the associated issuer-owned data but instead the appropriate action may be taken by providing to the transaction instrument user at the stand-alone device, the appropriate option for the action to be taken. System 100 contemplates a data storage arrangement wherein the header or trailer, or header or trailer history, of the data is stored on the transaction instrument in relation to the appropriate data.

One skilled in the art will also appreciate that, for security reasons, any databases, systems, devices, servers or other components of system 100 may consist of any combination thereof at a single location or at multiple locations, wherein each database or system 100 includes any of various suitable security features, such as firewalls, access codes, encryption, decryption, compression, decompression, and/or the like.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

The invention may be described herein in terms of functional block components, optional selections and various processing steps. It should be appreciated that such functional blocks may be realized by any number of hardware and/or software components configured to perform the specified functions. For example, system 100 may employ various integrated circuit components, e.g., memory elements, processing elements, logic elements, look-up tables, and/or the like, which may carry out a variety of functions under the control of one or more microprocessors or other control devices.

Similarly, the software elements of system 100 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Software elements (e.g., modules, engines, etc) may be implemented as a web service. In various embodiments, web services are implemented using Webservice Interoperability Organization Basic Profile 1.1.

Further, it should be noted that system 100 may employ any number of conventional techniques for data transmission, signaling, data processing, network control, and/or the like. Still further, system 100 could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by & O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory (or “computer-readable medium”) that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

System 100 combines unique app, integration, notification and value transfer features to enable a seamless value transfer services. While certain embodiments of the present invention are disclosed herein in terms of integration with a social gaming service, practitioners will appreciate that the teachings of the present invention may be equally applicable interchangeably between any type of service or application that enable searching for or otherwise identifying the users of the system or service.

Referring again to FIG. 1, in various embodiments, in response to user 105 logging onto an application, Internet server 125 may invoke an application server 145. Application server 145 invokes logic in VTE 147 by passing parameters relating to the user's 105 requests for data, transfer service 115 manages requests for data from VTE 147 and communicates with system 101 components. Transmissions between user 105 and Internet server 125 may pass through a firewall 120 to help ensure the integrity of transfer service 115 components. Practitioners will appreciate that the invention may incorporate any number of security schemes or none at all. In various embodiments, Internet server 125 receives requests from client 110 and interacts with various other system 100 components to perform tasks related to requests from client 110.

Internet server 125 may invoke an authentication server 130 to verify the identity of user 105 and assign roles, access rights and/or permissions to user 105. In order to control access to the application server 145 or any other component of transfer service 115, Internet server 125 may invoke an authentication server 130 in response to user 105 submissions of authentication credentials received at Internet server 125. In response to a request to access system 100 being received from Internet server 125, Internet server 125 determines if authentication is required and transmits a prompt to client 110. User 105 enters authentication data at client 110, which transmits the authentication data to Internet server 125. Internet server 125 passes the authentication data to authentication server which queries the user database 140 for corresponding credentials. When user 105 is authenticated, user 105 may access various applications and their corresponding data sources.

Transfer service 115 enables user 105 (e.g., a user of social networking service 180) to configure, register for, transfer value, receive value, fund prepaid accounts, etc. In various embodiments, transfer service 115 enables the functionality of a transfer received from an app such as VTAPP 160.

In various embodiments, the value to be transferred may comprise, for example, monetary value, a virtual currency, a virtual good, a virtual service and reward points. An example of a virtual currency may be points, “gold coins” or the like associated with an online game or a game associated with social gaming service 160. An example of a virtual good may be an asset in a simulation game such as a tractor in the popular Facebook game “Farmville.”

In various embodiments, VTAPP 160 and/or Social gaming service 180 may send a notification to the value deposit to participant 105. For instance, VTAPP 160 may send notification via email, text message (e.g. short message service), etc. For example, VTAPP 160 may obtain email addresses, phone numbers, etc. of the participant 105 from a social networking service and/or Social gaming service 180 and may use such information in sending the notification of the value deposit to the participant 105.

In various embodiments, VTAPP 160 may determine, as disclosed above, that participant 105 is a registered user of transfer service 115 and send a notification of the value transfer to the value recipient via transfer service 115's messaging module; e.g. an account notifications module that causes a message to be displayed to a transfer service 115 user on a notifications interface of the system.

The value recipient views the notification of the value transfer and takes action to complete the value transfer. For instance, the value recipient may view a notification of the value transfer on the value recipient's Facebook wall. The notification message may comprise a link or button that, when accessed by the value recipient, directs the user to an application associated with transfer service 115. In various embodiments, the application that the value recipient is directed to via the notification message may be VTAPP 160 and/or may be a web page interface of transfer service 115. For purposes of illustration, the following disclosure discusses embodiments where, in response to clicking an object (e.g. a hyperlink) included in the notification message, the value recipient is directed to VTAPP 160.

Value recipient is prompted to register for VTAPP 160. A registration process presents value recipient with an interface and value recipient enters identifying information. In various embodiments, the hyperlink from the notification may have encoded within it, profile information (e.g., social network user identifier, name, etc.) about the value recipient and VTAPP 160 may auto-populate this information in the registration interface.

VTAPP 160 communicates the registration information to transfer service 115, transfer service 115 receives the registration information as a registration request. In response to receiving the registration request, transfer service 115 and/or its various modules (e.g., workflow engine 148) completes the registration process for the value recipient. In various embodiments, transfer service 115 validates and/or verifies the registration information as part of the registration process. For example, transfer service 115 may receive a primary account identifier (e.g. email address) and a secondary user identifier (e.g. Facebook ID) as part of the registration request, transfer service 115 may execute logic to determine whether, for example, the primary user identifier is already present in the primary user identifier table of CDR 150, whether the secondary user identifier received in the registration request is already present in the secondary user identifier table, whether the secondary user identifier is already associated with a different primary account identifier, etc. In various embodiments, any of these conditions may cause an error in the registration process and/or transfer service 115 may initiate a process to query the user to reconcile and/or correct the registration information.

In various embodiments, completing the registration process includes inserting a row into the primary account identifier table. In various embodiments, transfer service 115 also inserts a row in the secondary account identifier table and an account identifier cross-reference table. One of skill in the art will recognize that transfer service 115 may make use of a wide range of database configurations, designs and table definitions, and the database schema discussed herein is disclosed as merely an example of a schema that is used in various embodiments. For example, in various embodiments, the secondary identifier table may contain a cross-reference (e.g. a primary or foreign key relationship) to the primary identifier table. Furthermore, secondary identifiers may be nested into a hierarchy of an unlimited number of sublevels such at there exist secondary, tertiary, fourth-level etc. identifiers which may all relate, directly or indirectly, to a single primary account identifier. In various embodiments, a parent account identifier may be associated with a child account identifier. For example, a parent account may be used as a funding source for a child account or impose restrictions on a child account. For more information regarding parent and child accounts, see U.S. Pat. No. 7,909,246 which issued on Mar. 22, 2011 and entitled System and Method for Establishment of Rules Governing Child Accounts, which is hereby incorporated by reference in its entirety.

In various embodiments, in response to a row being inserted in the primary account identifier table, transfer service 115 may automatically (e.g. via a database trigger that fires upon the event of a row insertion) initiate a process to determine whether there are any pending transactions for the newly registered user (e.g. the value recipient). In an embodiment, transfer service 115 identifies the pending transaction record (e.g. the row that was inserted in the pending transaction table by the transfer value request) by matching the secondary account identifier of the (newly registered) value recipient user with the account identifier inserted in the pending transactions table.

In various transactions, completing the transfer of value from transfer service 115 to social gaming service 180 may include updating the pending transactions table and updating a transaction history, audit or reporting table. In various embodiments, completing the value transfer may comprise presenting the value recipient/participant 105 with the pending transaction/deposit of value and prompting the value recipient to at least one of approve, decline or modify the pending transaction/deposit of value.

As discussed above, transfer service 115 may enable transfer and/or accrual of a wide array of value such as, for example, money, international currency, virtual currency, virtual goods; etc. As such, in various embodiments, transfer service 115 enables multiple value accounts that are identified via a primary account identifier and may be associated with multiple secondary account identifiers. For example, in various embodiments, user value accounts may be set up as “purses” and there may be one “purse” for each type of value that might be transferred (e.g. a virtual currency purse, a Zynga gold coin purse, a Farmville virtual asset purse, a US dollar purse, a Euro purse, a rewards account purse, etc.) In an embodiment, transfer service 115 enables a marketplace for exchanging or converting value from one type to another (e.g. convert US dollars to rewards points or transfer a tractor in Farmville in exchange for gold coins in Zynga poker).

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to ‘at least one of A, B, or C’ is used in the claims or specification, it is intended that the phrase be interpreted to mean that A alone may be present in various embodiments, B alone may be present in various embodiments, C alone may be present in various embodiments, or that any combination of the elements A, B and C may be present in a single embodiment; for example, A and B, A and C, B and C, or A and B and C. All structural, chemical, and functional equivalents to the elements of the above-described exemplary embodiments that are known to those of ordinary skill in the art are expressly incorporated herein by reference and are intended to be encompassed by the present claims. Further, a list of elements does not include only those elements but may include other elements not expressly listed or inherent to such process, method, article, or apparatus.

1. A computer-based method comprising:
receiving, by a computer-based system configured for exchanging information over a computerized network, transaction account activity information associated with an open loop pre-paid transaction account;
retrieving, by the computer-based system, information from a loyalty program database associated with the open loop prepaid transaction account, including a designation of a first virtual purse selected by a participant to deposit value and eligible rewards based on the activity associated with the open loop prepaid transaction account;
assessing, by the computer-based system, an amount of value to be deposited in the designated first virtual purse, based on the eligible reward activity associated with the open loop pre-paid transaction account using a computerized conversion processor, wherein the assessment is specific to the selected first virtual purse; and
transmitting, by the computer-based system, information associated with the assessed amount of value to be deposited in the designated first virtual purse.

2. The method of claim 1, wherein the value deposit comprises an open loop pre-paid transaction account identifier and a first virtual purse user identifier.

3. The method of claim 1, wherein the value is at least one of an amount of virtual currency and amount of virtual goods.

4. The method of claim 1, further comprising verifying, by the computer-based system, that the activity associated with the open loop prepaid transaction account is eligible to earn value in the selected first virtual purse.

5. The method of claim 1, further comprising updating a table of conversion rates for the designated virtual purse.

6. The method of claim 1, wherein activation of the open loop pre-paid transaction account comprises a transaction account activity.

7. The method of claim 1, wherein spend via the open loop pre-paid transaction account comprises a transaction account activity.

8. The method of claim 7, wherein the spend via the open loop pre-paid transaction account is associated with products that are not associated with the host of the virtual purse.

9. The method of claim 1, further comprising proportioning, by the computer-based system, an amount of value to be deposited between the designated first virtual purse and a second designated virtual purse.

10. The method of claim 1, wherein the transmitting of the information detailing the assessed amount of value to be deposited in the designated first virtual purse is transmitted substantially in concert with a transaction authorization request associated with the open loop pre-paid transaction account.

11. The method of claim 1, further comprising:
issuing, by the computer-based system, the open loop pre-paid transaction account to the participant; and
linking the participant's gaming user identification with the issued open loop pre-paid transaction account.

12. The method of claim 1, wherein the first virtual purse comprises a social gaming virtual purse.

13. The method of claim 1, further comprising awarding a reward of loyalty points to the open loop pre-paid transaction account, in addition to the deposit of the value in the selected first virtual purse.

14. The method of claim 1, further comprising adjusting the designated first virtual purse selected by the participant to deposit the value to a second virtual purse, wherein the assessment is specific to the second virtual purse.

15. The method of claim 1, wherein the transmitting of the information detailing the assessed amount of value to be deposited in the designated first virtual purse is automatic, in response to the assessment and detection of eligible reward activity.

16. The method of claim 1, wherein the value deposit request associated with an open loop pre-paid transaction account is based on an engagement trigger.

17. The method of claim 1, wherein a physical open loop pre-paid transaction instrument associated with the open loop pre-paid transaction account is co-branded with a designator of the holder of the first virtual purse.

18. The method of claim 1, wherein a notification is transmitted to the participant that the assessed amount of value has been delivered to the selected first virtual purse.

19. A system comprising:
a value transfer processor;
a tangible, non-transitory memory configured to communicate with the processor, the tangible, non-transitory memory having instructions stored thereon that, in response to execution by the processor, cause the processor to perform the operations comprising:
receiving, by the processor, transaction account activity information associated with an open loop pre-paid transaction account;
retrieving, by the processor, information from a loyalty program database associated with the open loop pre-paid transaction account, including a designation of a first virtual purse selected by a participant to deposit value and eligible rewards based on the activity associated with the open loop pre-paid transaction account;
assessing, by the processor, an amount of value to be deposited in the designated first virtual purse, based on the eligible reward activity associated with the open loop pre-paid transaction account using a computerized conversion processor, wherein the assessment is specific to the selected first virtual purse; and
transmitting, by the processor, information associated with the assessed amount of value to be deposited in the designated first virtual purse.

20. An article of manufacture including a non-transitory, tangible computer readable storage medium having instructions stored thereon that, in response to execution by a value transfer computer, cause the value transfer computer to perform the operations comprising:
receiving, by the value transfer computer, transaction account activity information associated with an open loop pre-paid transaction account;
retrieving, by the value transfer computer, information from a loyalty program database associated with the open loop pre-paid transaction account, including a designation of a first virtual purse selected by a participant to deposit value and eligible rewards based on the activity associated with the open loop pre-paid transaction account;
assessing, by the value transfer computer, an amount of value to be deposited in the designated first virtual purse, based on the eligible reward activity associated with the open loop pre-paid transaction account using a computerized conversion processor, wherein the assessment is specific to the selected first virtual purse; and
transmitting, by the value transfer computer, information associated with the assessed amount of value to be deposited in the designated first virtual purse.
